(19) United States
(12) Patent Application Publication
(10) Pub. No.: US 2020/0364217 A1
(43) Pub. Date: Nov. 19, 2020

(54) PERFORMING LIMITED JOIN QUERIES INVOLVING MULTIPLE TABLES WITH NON-STRUCTURED QUERY LANGUAGE DATABASES

(71) Applicant: Intel Corporation, Santa Clara, CA (US)

(72) Inventor: Xintian Wu, West Linn, OR (US)

(21) Appl. No.: 16/986,430

(22) Filed: Aug. 6, 2020

(51) Int. Cl. G06F 16/242; G06F 16/338; G06F 16/332; G06F 16/25

(52) U.S. Cl. CPC G06F 16/2423; G06F 16/258; G06F 16/3325; G06F 16/338

(57) ABSTRACT

Systems, apparatuses and methods may provide for technology that detects a search request and automatically obtains a plurality of query responses from a database in response to the search request, wherein the plurality of query responses includes an aggregate response associated with a first data structure and one or more additional responses associated with one or more additional data structures. The technology may also generate a response to the search request based on the one or more additional responses.

### TECHNICAL FIELD

Embodiments generally relate to querying data structures. More particularly, embodiments relate to performing limited join queries involving multiple tables with non-structured query language (NoSQL) databases.

### BACKGROUND

The ability to perform complex queries on multiple tables or indexes may be useful in a variety of applications such as TOT (Internet of Things) video analytics systems, smart city traffic planning systems, autonomous driving training data management systems, and so forth. SQL (structured query language) join operations may enable programmers to combine columns from multiple tables by using values that are common to each table. SQL databases, however, typically have ACID (atomicity, consistency, isolation, durability) requirements that limit performance, particularly with respect to complex queries. While NoSQL databases may be combined with data normalization to perform complex queries, there remains considerable room for improvement. For example, data normalization may involve duplicating/copying columns from one table to another. Such an approach may increase the amount of data and slow down data updates, which in turn presents scalability and/or storage concerns.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a query architecture according to an embodiment;

FIG. 2 is an illustration of an example of a plurality of data structures according to an embodiment;

FIG. 3 is a flowchart of an example of a method of operating a performance-enhanced computing system according to an embodiment;

FIG. 4 is a flowchart of an example of a more detailed method of operating a performance-enhanced computing system according to an embodiment;

FIG. 5 is a block diagram of an example of a performance-enhanced computing system according to an embodiment;

FIG. 6 is an illustration of an example of a semiconductor apparatus according to an embodiment;

FIG. 7 is a block diagram of an example of a processor according to an embodiment; and

FIG. 8 is a block diagram of an example of a multi-processor based computing system according to an embodiment.

### DESCRIPTION OF EMBODIMENTS

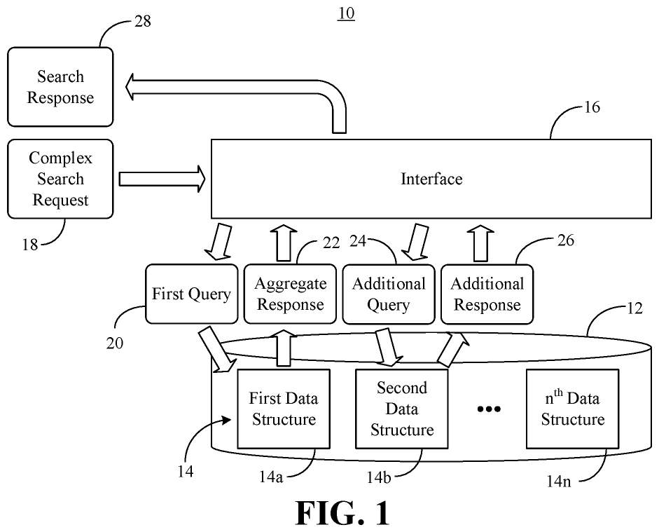

Turning now to FIG. 1, a query architecture 10 is shown in which a database 12 includes a plurality of data structures 14 (14a-14n, e.g., tables, indexes). The data structures 14 might store data relating to IOT video analytics systems, smart city traffic planning systems, autonomous driving training data management systems, and so forth. In the illustrated example, an interface 16 (e.g., implemented in logic instructions, configurable logic, fixed-functionality hardware logic, etc., or any combination thereof) detects a search request 18, where the search request 18 is considered to be complex because the request 18 involves two or more of the data structures 14. For example, the search request 18 might involve/reference a field and/or column that is in a first data structure 14a and not in a second data structure 14b, while also involving/referencing a field and/or column that is in the second data structure 14b and not in the first data structure 14a. Rather than generating a SQL join operation (e.g., INNER JOIN, LEFT OUTER JOIN, RIGHT OUTER JOIN, FULL OUTER JOIN, CROSS JOIN and/or complex WHERE), the illustrated interface 16 automatically generates a first query 20 based on the search request 18 and issues the first query 20 to the database 12, where the first query 20 includes a request to “bucketize” a field in the first data structure 14a. As a result, the database 12 may return an aggregate response 22 to the first query 20, where the aggregate response 22 lacks records from the first data structure 14a.

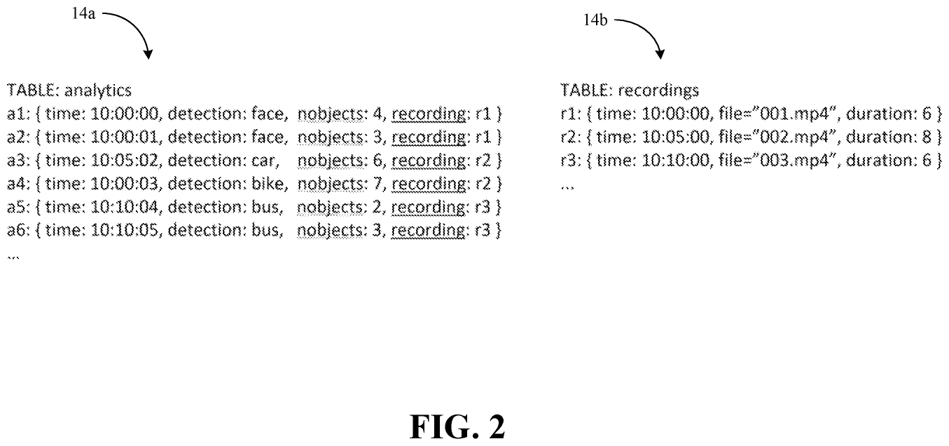

By way of example, and with continuing reference to FIGS. 1 and 2, the second data structure 14b might be a recordings table that contains the recordings of camera streams and corresponding meta information (e.g., timestamp, duration). Additionally, the first data structure 14a may be an analytics table that contains the per-frame analytics data of the corresponding camera streams. The fields, such as detection, duration, time, and nobjects, are optional and examples of fields for illustration purposes. By contrast, the illustrated recording field links the two tables together. The recording field may be inserted at ingest time, or post-processed offline based on additional information such as the time field.

Such a schema is generic to a wide range of application scenarios such as, for example, in IOT camera surveillance systems, smart city traffic planning systems, smart stadium management systems, and retail planning and management.

In one example, the subject of the search request 18 is all recordings whose duration is more than five seconds, and the corresponding analytics data detection is “face” and nobjects is more than three. In a SQL database, such a request may involve a JOIN operation of the two data structures 14a, 14b.

To generalize, a solution is implemented that may perform a joined query such as queries on recordings WHERE queries on analytics. In an embodiment, the queries are be implemented as follows:

Perform the first query 20 on the analytics table or index. Of particular note is that the actual data records from the analytics table/index are not needed to complete the search request 18. Thus, instead of receiving perhaps billions of analytics records, the interface 16 simply requests the database 12 to bucketize the recording field. The returned result is a unique list of recording ids (identifiers), for example, r1, r2, and r3. Using the query of checking if detection is face as an example, the following search may be automatically performed:

{“query”: {“bool”: {“must”: [{“term”: {“detection.keyword”: “face”}}, {“range”: {“nobjects”: {“gt”: 3}}}]}}, “size”: 0, “aggs”: “recordings”: “terms”: {“field”: “recording.keyword”}}}}

Result: { . . . aggregations: {“recordings”: [“r1”]}

Perform an additional query 24 on the second data structure 14b (e.g., the recordings table or index), with the recording ids as the constraint, the returned result is an additional response 26 containing a list of recording files that satisfy the combined queries. For example, the search duration>5 might be performed as:

Query: {“query”: {“bool”: {“must”: [{“ids”: [“r1”]}, {“bool”: {“must”: [{“range”: {“duration”: {“gt”: 5}}}]}}]}}}

Result: { . . . hits: {hits: [ . . . {time: 10:00:00, file=“001.mp4”, duration: 6} . . . ]}}

In the illustrated example, the interface 16 generates a search response 28 based on the additional response 26. Assuming that there are N records in the analytics table and M records in the recordings table, the complexity of a merge JOIN operation on the two tables is O(N*M) in general. The disclosed solution reduces the complexity to O(N+M). Accordingly, the illustrated architecture 10 enhances performance (e.g., real-time responsiveness) because the amount of time associated with generation of the search response 28 is linear to the amount of data in the database 12. In an embodiment, the database 12 is a NoSQL database that already has higher performance than a SQL database due to a lack of ACID requirements.

Table I below shows performance data, assuming that each recording is about 5 seconds long and the frame rate is 30 fps. The performed queries in a SQL equivalent is: SELECT DISTINCT recordings.time, recordings. file FROM analytics, recordings WHERE analytics.detection=“car” AND analytics.nobjects>50 AND recordings. duration>10 LIMIT 1000:

TABLE I

| #analytics | #recordings | MySQL (SQL) | ElasticSearch (No-SQL) |
|---|---|---|---|
| 1,500 records | 10 | 9 ms | 2.95 ms |
| 15,000 records | 100 | 32 ms | 3.15 ms |
| 150,000 records | 1,000 | 2,633 ms | 5.16 ms |

For a complex query that involves more than two of the data structures 14 (e.g., tables 1 to N), the “bucketize” operation may be done on the first data structure 14a (e.g., table 1), then on the second data structure (e.g., table 2), then on a third data structure (e.g., table 3, not shown) all the way to the n−1^{th} data structure (e.g., table N−1, not shown). Then, the final query may be performed on the n^{th} data structure 14n (e.g., table N) to retrieve the results. Thus, the additional response 26 may also be an aggregate response, depending on the circumstances.

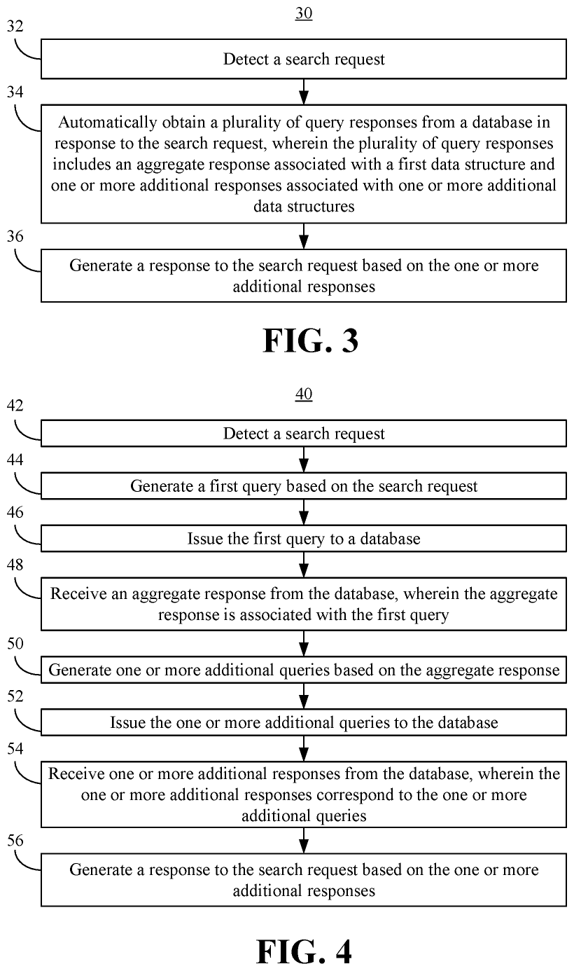

FIG. 3 shows a method 30 of operating a performance-enhanced computing system. The method 30 may generally be implemented in an interface such as, for example, the interface 16 (FIG. 1), already discussed. More particularly, the method 30 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 30 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 32 detects a search request. In an embodiment, the search request is a complex search request that involves multiple data structures (e.g., tables, indexes). Block 34 automatically obtains a plurality of query responses from a database in response to the search request, wherein the plurality of query responses includes an aggregate response associated with a first data structure and one or more additional responses associated with one or more additional data structures. As already noted, the additional response(s) may also include one or more aggregate responses (e.g., when more than two data structures are involved). In one example, the first query includes a request to bucketize a field (e.g., column) in the first data structure. Additionally, the aggregate response may lack records from the first data structure. In an embodiment, the plurality of query responses is obtained from a NoSQL database. Illustrated block 36 generates a response to the search request based on the one or more additional responses.

Obtaining the aggregate response from the first data structure may enable the amount of time associated with generation of the response to the search request to be linear to the amount of data in the database (see, e.g., Table I). Accordingly, performance may be significantly enhanced in a wide variety of applications such as, for example, IOT video analytics systems, smart city traffic planning systems, autonomous driving training data management systems, and so forth. Performance may be further enhanced by eliminating data normalization operations (e.g., duplicating/copying columns from one table to another), which may otherwise increase the amount of data, slow down data updates and present scalability and/or storage concerns. Additionally, obtaining the aggregate response may reduce the amount of I/O (input/output) involved to return the result. The I/O may be memory bandwidth (e.g., if the database and the query are on the same machine) or network bandwidth (e.g., if the database and the query are on different machines.)

FIG. 4 shows a more detailed method 40 of operating a performance-enhanced computing system. The method 40 may generally be implemented in an interface such as, for example, the interface 16 (FIG. 1), already discussed. More particularly, the method 40 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 42 provides for detecting a search request. In an embodiment, the search request is a complex search request that involves multiple data structures (e.g., tables, indexes). A first query is generated at block 44 based on the search request, where block 46 issues the first query to a database. As already noted, the first query may include a request to bucketize a field/column in a first data structure. In an embodiment, block 48 receives an aggregate response from the database, wherein the aggregate response is associated with the first query. In one example, the aggregate response lacks (e.g., does not contain) any records from the first data structure. Rather, the aggregate response may merely be a unique list of identifiers.

Block 50 may generate one or more additional queries based on the aggregate response, where block 52 issues the one or more additional queries to the database. In an embodiment, block 54 receives one or more additional responses from the database. In the illustrated example, the one or more additional responses correspond to the one or more additional queries. Block 56 generates a response to the search request based on the one or more additional responses. As already noted, the database may be a NoSQL database. Moreover, the amount of time associated with generation of the response to the search request may be linear to the amount of data in the database.

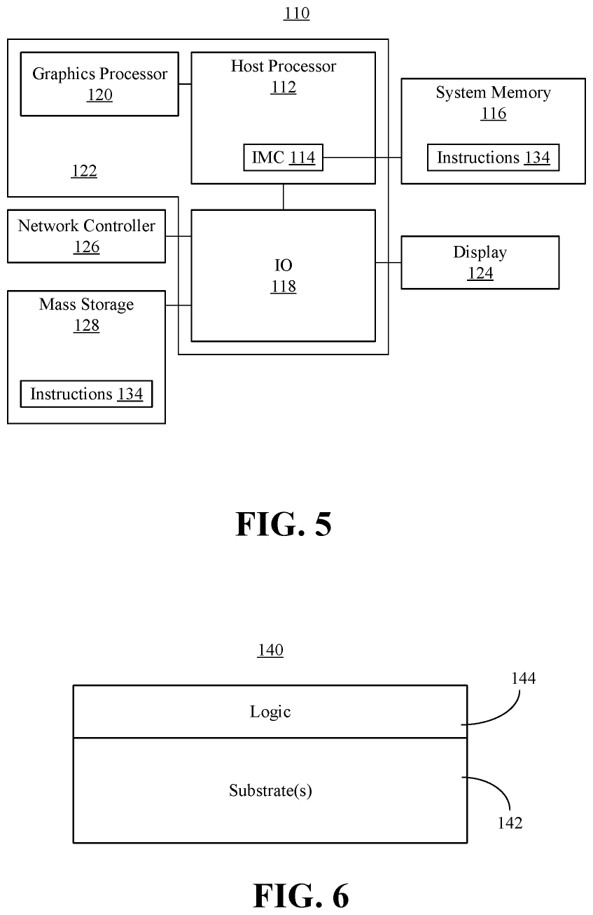

Turning now to FIG. 5, a performance-enhanced computing system 110 is shown. The system 110 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof. In the illustrated example, the system 110 includes a host processor 112 (e.g., central processing unit/CPU) having an integrated memory controller (IMC) 114 that is coupled to a system memory 116.

The illustrated system 110 also includes an input output (IO) module 118 implemented together with the host processor 112 and a graphics processor 120 (e.g., graphics processing unit/GPU) on a semiconductor die 122 as a system on chip (SoC). The illustrated IO module 118 communicates with, for example, a display 124 (e.g., touch screen, liquid crystal display/LCD, light emitting diode/LED display), a network controller 126 (e.g., wired and/or wireless), and mass storage 128 (e.g., hard disk drive/HDD, optical disk, solid state drive/SSD, flash memory).

In an embodiment, the host processor 112, the graphics processor 120 and/or the IO module 118 execute program instructions 134 retrieved from the system memory 116 and/or the mass storage 128 to perform one or more aspects of the method 30 (FIG. 3) and/or the method 40 (FIG. 4), already discussed. Thus, execution of the instructions 134 may cause the semiconductor die 122 and/or the computing system 110 to detect a search request and automatically obtain a plurality of query responses from a database in response to the search request. The plurality of query responses may include an aggregate response associated with a first data structure and one or more additional responses associated with one or more additional data structures. Execution of the instructions 134 may also cause the semiconductor die 122 and/or the computing system 110 to generate a response to the search request based on the one or more additional responses. In an embodiment, the database is a NoSQL database. The computing system 110 is therefore performance-enhanced at least to the extent that obtaining the aggregate response enables the amount of time associated with generation of the response to the search request to be linear to the amount of data in the database. Performance may be further enhanced by eliminating data normalization operations (e.g., duplicating/copying columns from one table to another), which may otherwise increase the amount of data, slow down data updates and present scalability and/or storage concerns.

FIG. 6 shows a semiconductor package apparatus 140. The illustrated apparatus 140 includes one or more substrates 142 (e.g., silicon, sapphire, gallium arsenide) and logic 144 (e.g., transistor array and other integrated circuit/IC components) coupled to the substrate(s) 142. The logic 144 may be implemented at least partly in configurable logic or fixed-functionality logic hardware. In one example, the logic 144 implements one or more aspects of the method 30 (FIG. 3) and/or the method 40 (FIG. 4), already discussed. Thus, the logic 144 may detect a search request and automatically obtain a plurality of query responses from a database in response to the search request. The plurality of query responses may include an aggregate response associated with a first data structure and one or more additional responses associated with one or more additional data structures. The logic 144 may also generate a response to the search request based on the one or more additional responses. In an embodiment, the plurality of query responses is obtained from a NoSQL database. The apparatus 140 is therefore performance-enhanced at least to the extent that obtaining the aggregate response enables the amount of time associated with generation of the response to the search request to be linear to the amount of data in the database.

In one example, the logic 144 includes transistor channel regions that are positioned (e.g., embedded) within the substrate(s) 142. Thus, the interface between the logic 144 and the substrate(s) 142 may not be an abrupt junction. The logic 144 may also be considered to include an epitaxial layer that is grown on an initial wafer of the substrate(s) 142.

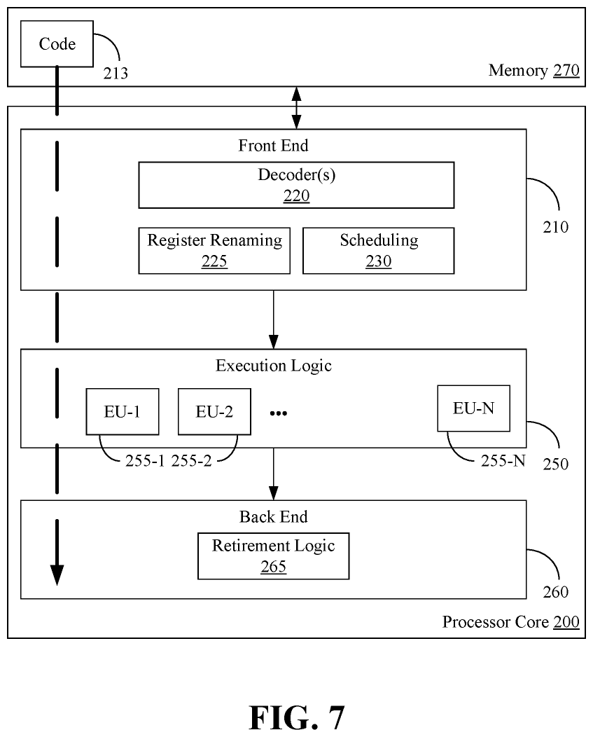

FIG. 7 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 7, a processing element may alternatively include more than one of the processor core 200 illustrated in FIG. 7. The processor core 200 may be a single-threaded core or, for at least one embodiment, the processor core 200 may be multithreaded in that it may include more than one hardware thread context (or “logical processor”) per core.

FIG. 7 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the method 30 (FIG. 3) and/or the method 40 (FIG. 4), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 7, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

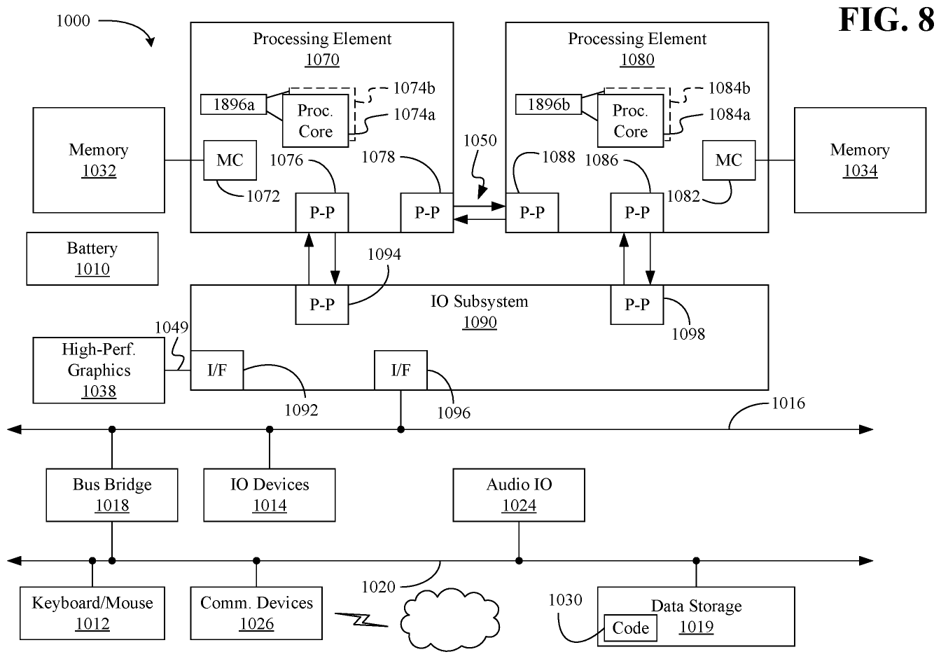

Referring now to FIG. 8, shown is a block diagram of a computing system 1000 embodiment in accordance with an embodiment. Shown in FIG. 8 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 8 may be implemented as a multi-drop bus rather than point-to-point interconnect.

As shown in FIG. 8, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 7.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 8, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 8, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 8, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement one or more aspects of the method 30 (FIG. 3) and/or the method 40 (FIG. 4), already discussed. Further, an audio I/O 1024 may be coupled to second bus 1020 and a battery 1010 may supply power to the computing system 1000.

Note that other embodiments are contemplated. For example, instead of the point-to-point architecture of FIG. 8, a system may implement a multi-drop bus or another such communication topology. Also, the elements of FIG. 8 may alternatively be partitioned using more or fewer integrated chips than shown in FIG. 8.

### ADDITIONAL NOTES AND EXAMPLES

Example 1 includes a computing system comprising a network controller, a processor coupled to the network controller, and a memory coupled to the processor, the memory including a set of executable program instructions, which when executed by the processor, cause the processor to detect a search request, automatically obtain a plurality of query responses from a database in response to the search request, wherein the plurality of query responses is to include an aggregate response associated with a first data structure and one or more additional responses associated with one or more additional data structures, and generate a response to the search request based on the one or more additional responses.

Example 2 includes the computing system of Example 1, wherein the instructions, when executed, further cause the processor to generate a first query based on the search request, issue the first query to the database, wherein the aggregate response is to correspond to the first query, generate one or more additional queries based on the aggregate response, and issue the one or more additional queries to the database, wherein the one or more additional responses are to correspond to the one or more additional queries.

Example 3 includes the computing system of Example 2, wherein the first query is to include a request to bucketize a field in the first data structure.

Example 4 includes the computing system of Example 1, wherein the aggregate response is to lack records from the first data structure.

Example 5 includes the computing system of Example 1, wherein the plurality of query responses is to be obtained from a non-structured language query (NoSQL) database.

Example 6 includes the computing system of any one of Examples 1 to 5, wherein an amount of time associated with generation of the response to the search request is to be linear to an amount of data in the database.

Example 7 includes a semiconductor apparatus comprising one or more substrates, and logic coupled to the one or more substrates, wherein the logic is implemented at least partly in one or more of configurable logic or fixed-functionality hardware logic, the logic coupled to the one or more substrates to detect a search request, automatically obtain a plurality of query responses from a database in response to the search request, wherein the plurality of query responses is to include an aggregate response associated with a first data structure and one or more additional responses associated with one or more additional data structures, and generate a response to the search request based on the one or more additional responses.

Example 8 includes the apparatus of Example 7, wherein the logic coupled to the one or more substrates is to generate a first query based on the search request, issue the first query to the database, wherein the aggregate response is to correspond to the first query, generate one or more additional queries based on the aggregate response, and issue the one or more additional queries to the database, wherein the one or more additional responses are to correspond to the one or more additional queries.

Example 9 includes the apparatus of Example 8, wherein the first query is to include a request to bucketize a field in the first data structure.

Example 10 includes the apparatus of Example 7, wherein the aggregate response is to lack records from the first data structure.

Example 11 includes the apparatus of Example 7, wherein the plurality of query responses is to be obtained from a non-structured language query (NoSQL) database.

Example 12 includes the apparatus of any one of Examples 7 to 11, wherein an amount of time associated with generation of the response to the search request is to be linear to an amount of data in the database.

Example 13 includes the apparatus of any one of Examples 7 to 11, wherein the logic coupled to the one or more substrates includes transistor channel regions that are positioned within the one or more substrates.

Example 14 includes at least one computer readable storage medium comprising a set of executable program instructions, which when executed by a computing system, cause the computing system to detect a search request, automatically obtain a plurality of query responses from a database in response to the search request, wherein the plurality of query responses is to include an aggregate response associated with a first data structure and one or more additional responses associated with one or more additional data structures, and generate a response to the search request based on the one or more additional responses.

Example 15 includes the at least one computer readable storage medium of Example 14, wherein the instructions, when executed, further cause the computing system to generate a first query based on the search request, issue the first query to the database, wherein the aggregate response is to correspond to the first query, generate one or more additional queries based on the aggregate response, and issue the one or more additional queries to the database, wherein the one or more additional responses are to correspond to the one or more additional queries.

Example 16 includes the at least one computer readable storage medium of Example 15, wherein the first query is to include a request to bucketize a field in the first data structure.

Example 17 includes the at least one computer readable storage medium of Example 14, wherein the aggregate response is to lack records from the first data structure.

Example 18 includes the at least one computer readable storage medium of Example 14, wherein the plurality of query responses is to be obtained from a non-structured language query (NoSQL) database.

Example 19 includes the at least one computer readable storage medium of any one of Examples 14 to 18, wherein an amount of time associated with generation of the response to the search request is to be linear to an amount of data in the database.

Example 20 includes a method of operating a performance-enhanced computing system, the method comprising detecting a search request, automatically obtaining a plurality of query responses from a database in response to the search request, wherein the plurality of query responses includes an aggregate response associated with a first data structure and one or more additional responses associated with one or more additional data structures, and generating a response to the search request based on the one or more additional responses.

Example 21 includes the method of Example 20, further including generating a first query based on the search request, issuing the first query to the database, wherein the aggregate response corresponds to the first query, generating one or more additional queries based on the aggregate response, and issuing the one or more additional queries to the database, wherein the one or more additional responses correspond to the one or more additional queries.

Example 22 includes the method of Example 21, wherein the first query includes a request to bucketize a field in the first data structure.

Example 23 includes the method of Example 20, wherein the aggregate response lacks records from the first data structure.

Example 24 includes the method of Example 20, wherein the plurality of query responses is obtained from a non-structured language query (NoSQL) database.

Example 25 includes the method of any one of Examples 20 to 24, wherein an amount of time associated with generation of the response to the search request is linear to an amount of data in the database.

Example 26 includes means for performing the method of any one of Examples 20 to 25.

The technology described herein therefore enables complex searches based on NoSQL databases, making it possible to serve a wide range of applications such as IOT embedded systems, edge analytics systems, cloud smart-city type systems or general neural network training-data management in autonomous driving scenarios. As the performance of NoSQL databases may be an order of magnitude faster than similar SQL databases, applications are now able to handle more data. Moreover, edge or IOT systems may use this additional capacity as a result without a need of a large database cluster. Specifically, for IOT systems, the added capability to store data in a database and perform searches may be advantageous. Platforms may also optimize the disclosed database query operations to make NoSQL databases operate more effectively on the platform in question. For example, INTEL OPTANE persistent memory may speed up NoSQL database operations even further.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, the memory including a set of executable program instructions, which when executed by the processor, cause the processor to:
detect a search request,
automatically obtain a plurality of query responses from a database in response to the search request, wherein the plurality of query responses is to include an aggregate response associated with a first data structure and one or more additional responses associated with one or more additional data structures, and
generate a response to the search request based on the one or more additional responses.

2. The computing system of claim 1, wherein the instructions, when executed, further cause the processor to:
generate a first query based on the search request,
issue the first query to the database, wherein the aggregate response is to correspond to the first query,
generate one or more additional queries based on the aggregate response, and
issue the one or more additional queries to the database, wherein the one or more additional responses are to correspond to the one or more additional queries.

3. The computing system of claim 2, wherein the first query is to include a request to bucketize a field in the first data structure.

4. The computing system of claim 1, wherein the aggregate response is to lack records from the first data structure.

5. The computing system of claim 1, wherein the plurality of query responses is to be obtained from a non-structured language query (NoSQL) database.

6. The computing system of claim 1, wherein an amount of time associated with generation of the response to the search request is to be linear to an amount of data in the database.

7. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
detect a search request;
automatically obtain a plurality of query responses from a database in response to the search request, wherein the plurality of query responses is to include an aggregate response associated with a first data structure and one or more additional responses associated with one or more additional data structures; and
generate a response to the search request based on the one or more additional responses.

8. The apparatus of claim 7, wherein the logic coupled to the one or more substrates is to:
generate a first query based on the search request;
issue the first query to the database, wherein the aggregate response is to correspond to the first query;
generate one or more additional queries based on the aggregate response; and
issue the one or more additional queries to the database, wherein the one or more additional responses are to correspond to the one or more additional queries.

9. The apparatus of claim 8, wherein the first query is to include a request to bucketize a field in the first data structure.

10. The apparatus of claim 7, wherein the aggregate response is to lack records from the first data structure.

11. The apparatus of claim 7, wherein the plurality of query responses is to be obtained from a non-structured language query (NoSQL) database.

12. The apparatus of claim 7, wherein an amount of time associated with generation of the response to the search request is to be linear to an amount of data in the database.

13. The apparatus of claim 7, wherein the logic coupled to the one or more substrates includes transistor channel regions that are positioned within the one or more substrates.

14. At least one computer readable storage medium comprising a set of executable program instructions, which when executed by a computing system, cause the computing system to:
detect a search request;
automatically obtain a plurality of query responses from a database in response to the search request, wherein the plurality of query responses is to include an aggregate response associated with a first data structure and one or more additional responses associated with one or more additional data structures; and
generate a response to the search request based on the one or more additional responses.

15. The at least one computer readable storage medium of claim 14, wherein the instructions, when executed, further cause the computing system to:
generate a first query based on the search request;
issue the first query to the database, wherein the aggregate response is to correspond to the first query;
generate one or more additional queries based on the aggregate response; and
issue the one or more additional queries to the database, wherein the one or more additional responses are to correspond to the one or more additional queries.

16. The at least one computer readable storage medium of claim 15, wherein the first query is to include a request to bucketize a field in the first data structure.

17. The at least one computer readable storage medium of claim 14, wherein the aggregate response is to lack records from the first data structure.

18. The at least one computer readable storage medium of claim 14, wherein the plurality of query responses is to be obtained from a non-structured language query (NoSQL) database.

19. The at least one computer readable storage medium of claim 14, wherein an amount of time associated with generation of the response to the search request is to be linear to an amount of data in the database.

20. A method comprising:
detecting a search request;
automatically obtaining a plurality of query responses from a database in response to the search request, wherein the plurality of query responses includes an aggregate response associated with a first data structure and one or more additional responses associated with one or more additional data structures; and
generating a response to the search request based on the one or more additional responses.

21. The method of claim 20, further including:
generating a first query based on the search request;
issuing the first query to the database, wherein the aggregate response corresponds to the first query;
generating one or more additional queries based on the aggregate response; and
issuing the one or more additional queries to the database, wherein the one or more additional responses correspond to the one or more additional queries.

22. The method of claim 21, wherein the first query includes a request to bucketize a field in the first data structure.

23. The method of claim 20, wherein the aggregate response lacks records from the first data structure.

24. The method of claim 20, wherein the plurality of query responses is obtained from a non-structured language query (NoSQL) database.

25. The method of claim 20, wherein an amount of time associated with generation of the response to the search request is linear to an amount of data in the database.
